(19) United States
(12) Patent Application Publication
(10) Pub. No.: US 2018/0233019 A1
(43) Pub. Date: Aug. 16, 2018

(54) SYSTEM AND METHOD FOR OPERATIONAL AND EXPOSURE INFORMATION RECORDING AND GESTURE ACTIVATED COMMUNICATION

(71) Applicant: EXTINQUAL INC., Arlington, VA (US)

(72) Inventors: Henry J. Werronen, Arlington, VA (US); Isamu G. Nakagawa, New York, NY (US)

(73) Assignee: EXTINQUAL INC., Arlington, VA (US)

(21) Appl. No.: 15/901,302

(22) Filed: Feb. 21, 2018

Related U.S. Application Data
(63) Continuation-in-part of application No. PCT/US2016/047915, filed on Aug. 19, 2016.
(60) Provisional application No. 62/207,953, filed on Aug. 21, 2015.
(60) Provisional application No. 62/277,004, filed on Jan. 11, 2016.
(60) Provisional application No. 62/322,431, filed on Apr. 14, 2016.

(51) Int. Cl. G08B 21/04; G08B 25/10; G08B 27/00; G08B 21/18

(52) U.S. Cl. CPC G08B 21/0453; G08B 21/182; G08B 27/001; G08B 25/10

(57) ABSTRACT

A system and method for operational and exposure information recording and communication with emergency scene first responders. The system and method includes at least one sensor worn by first responders, which measures operational or exposure conditions of the first responders at an emergency scene, and a smart device associated with each first responder for transmitting data from the sensors and receiving communications. A responder information center and an incident control center both wirelessly receive, analyze and store data the operational or exposure conditions of the first responders. The incident control center is further configured to transmit a warning message when operational or exposure conditions exceed predetermined parameters. This warning message can be nonverbal.

### CROSS-REFERENCE TO RELATED APPLICATIONS

This application is a Continuation In Part Application of PCT International Application Serial No. PCT/US2016/047915 titled “System and Method for Gesture Activated Responder Lighting and Information Center,” filed Aug. 19, 2016, claiming priority to U.S. Provisional Application Ser. No. 62/207,953 filed on Aug. 21, 2015; U.S. Provisional Application Ser. No. 62/277,004 filed on Jan. 11, 2016; and U.S. Provisional Application Ser. No. 62/322,431 filed on Apr. 14, 2016, each incorporated by reference herein in its entirety.

### FIELD OF THE INVENTION

The present invention is a system and method for operational and exposure information recording and nonverbal or gesture activated communication for use by firefighters, police, rescue workers, military, miners, and others in emergency/high risk situations (collectively, “First Responders”).

### BACKGROUND

First Responders face both contemporaneous and long-term health and safety hazards in performing their jobs. On a contemporaneous basis, a First Responder setting can present numerous health and safety hazards, including exposure to fire, heat, and toxic fumes and liquids, and the dangers of poor visibility resulting from smoke. Recognizing, recording and communicating these hazards are critical to the safety of the First Responders. Similarly, redundant and/or alternative methods of communicating such hazards on a real-time basis are critical both among First Responders and between First Responders and an incident control center.

Likewise, it is critical for the health of first responders to record exposure to such hazards on a long-term basis. According to a multi-year study by the National Institute for Occupational Safety and Health (NIOSH), the 30,000 First Responders they studied showed higher rates of certain types of cancer than the general U.S. population, including digestive, oral, respiratory and urinary cancers. This study presented evidence that the increased risk is a result of occupational exposure. The potential job exposure was based on existing records for the number of exposed-days, fire-runs and fire-hours. One of the limitations of the study—the lack of actual exposure measurements—has provided an impetus for the development of the present invention. The details of the study are at www.cdc.gov/niosh/firefighters/ffcancerstudy.

Recognizing the well-documented concerns about cancer and cardiovascular risks for First Responders, the Illinois Fire Service Institute has conducted a multi-dimensional research project to measure the acute thermal and cardiovascular strain of firefighting and the long-term exposure to products of combustion. The goal of this study is to produce rigorous scientific data on the effects of firefighting on firefighter cardiovascular and cancer risks in a typical modern structure with realistic fuel loads. The measurements developed in this study form the basis for the measurement strategy incorporated in the present invention including temperature, heart rate, toxic gases and particles, time-in-fire and self-contained breathing apparatus (“SCBA”) use both in active-fire and overhaul stages. The details of the study are at https://www.fsi.illinois.edu/documents/research/CardioChemRisksModernFF_InterimReport2016.pdf.

As such, one goal of the present invention is preventing the onset and progression of chronic diseases among First Responders that are largely due to occupational risks. The current lack of an effective way to track exposure to operational risks is a blind spot in the on-going initiatives to protect the health and safety of First Responders. In this respect, the present invention functions like the Blind Spot Monitors on automobiles, which issue warnings when another auto is in the blind spot of the driver on a side of the car. In the context of this goal, the present invention is intended to be used in conjunction with on-going industry initiatives for better personal protective equipment, improved firefighting operating procedures and increased medical awareness and screening for health risks.

In addition, another related goal of the present invention is to provide for improved communications to and among First Responders insofar as they operate in a challenging environment that is often not only dark, but also often smoky, wet, noisy and lacking a floor plan or map. Operating in dark and smoky conditions, it is often difficult for First Responders (i) to see their team member ahead of them and know the direction they are going, (ii) to know if there is a potentially dangerous situation ahead and/or (iii) to know if the team needs to exit to replenish its supply of oxygen. As such, providing light in the space surrounding First Responders, in all directions, is critical for their safety and for their goal of protecting victims and property. Since First Responders are often carrying other tools and equipment, such as a fire hose or axe, the ability to operate a hands-free lighting system overcomes the need to hold a separate flashlight that would otherwise limit overall effectiveness. In addition, it is critical for First Responders to be able to communicate with each other and the incident commander outside the immediate rescue scene at an incident control center in order to provide for their safety and effective operation. However, radio or smart device communication is not possible for First Responders in many cases; moreover, when First Responders are wearing an oxygen mask, it is not possible for them to call out to other members of their team. As such, a non-verbal communication system in the form of light sequences—which respond to user commands and sensor indications of hazardous conditions—is desirable, novel and beneficial.

Finally, while operating in the challenging environments that First Responders encounter, it is virtually impossible to create an accurate record of the activity of First Responders and the conditions they are facing. A “black box” system that would automatically record their activities and the operating conditions inside the rescue scene therefore would be useful in protecting the health and safety of First Responders, in creating a post-rescue analysis of the incident and in providing a tool for training and education of First Responders.

### BRIEF SUMMARY OF THE INVENTION

The invention is an integrated and programmable operational and exposure data/information recordation and communication system and related method that address the needs of First Responders, in dangerous and dark conditions, for (i) operational and exposure data recordation, and (ii) improved communications, including, without limitation, nonverbal or hands free lighting.

In one embodiment of the present invention, one or more First Responders are equipped with a standard smart device or smart phone (preferably worn and protected inside turnout gear) that acts as the communications hub for capturing operational data generated by sensors mounted on the Personal Protective Equipment (such as a wristband or belt assembly or elsewhere) of a First Responder or worn directly on the body of the First Responder. The sensors capture data as to location/movement, as well as environmental, biometric conditions, including, without limitation, temperature, heart rate, and SCBA status via a Bluetooth, LTE or any other available wireless technology connection with wearable sensors. This operational data is automatically uploaded to a secure cloud-based system and stored in a database management system that is used to drive reporting and application programs through an application programming interface. The individual operational data that is captured automatically is augmented by input from an incident safety officer or other individuals at an incident control center for data common to all members of the firefighting team and readily available as part of the safety officer's normal duties. This includes data such as, without limitation, incident identification, fire-under-control time, over haul time, measurement of toxic gases and on-site decontamination of personal protective equipment (“PPE”).

This exposure data/information, in turn, allows for improved communication to and among First Responders. In this respect and in another embodiment, the method and system of the invention is configured to communicate wirelessly with an incident control center, and the system includes (1) a responder information center that acts to receive and record information and data from First Responder, and (2) a responder communication system that, in one embodiment, is based on lighting and lighting sequences. In this embodiment, the information and responder lighting and information system, in turn, includes, for each First Responder user, (a) at least one exposure/environmental or operational sensor mounted on the PPE or body of the First Responder, (b) a wrist lighting assembly with area lights and, through gestures and motions of the gloves, generates corresponding predetermined gesture patterns; (c) a belt assembly with lights and that is attached to the rear of the First Responder, preferably on his/her jacket; and (d) a programmable smart phone or similar device that is configured to communicate with the wrist lighting assembly and belt assembly of the same First Responder user, smart devices associated with other First Responder users, the incident control center, and the responder information center. In operation, (i) gesture patterns are communicated from the wrist lighting assembly to the smart device, (ii) data from the exposure/environmental or operational sensors of the lighting wrist assembly and belt assembly is communicated to the smart device and, from the smart device, to the incident control center; and (iii) the smart device processes the gesture patterns and sensor data and generates lighting activation and/or sequence commands to the wrist lighting assembly and belt assembly and corresponding messages to the incident control center. In particular, exposure/environmental sensor data, such as an indication from a heat sensor that temperature has reached a certain level or increased over a predetermined range in a predetermined period of time, can trigger warning lights on the wrist lighting assembly and a warning light sequence on the belt assembly. Exposure/environmental sensor data can also focus on the measurement of various gases at a response scene, including toxic gases. In this embodiment, the exposure/environmental sensors can be mounted elsewhere, and these sensors can also include biometric sensors, measuring, for example, skin temperature and heart rate, mounted directly on a First Responder. Operational sensors can also be mounted in various locations on a First Responder and can measure, for example, movement and/or location of the First Responder and the time frame over which a First Responder experiences certain conditions or that certain equipment, such as SCBA is operational and time frame of such operation. In this respect, various types of sensors can be used to measure and assess the operation/movement, environment and biometrics of a First Responder, and the sensors described above are examples only. In addition, the lighting activation and pattern commands can activate the lights on the wrist lighting assembly and belt assembly and can generate light sequences on the belt assembly, with these sequences providing for gesture-based interaction and associated visual communications between First Responders in their immediate area. More specifically, the system and method of the present invention allows each First Responder to generate predetermined light sequences, which signal corresponding message, on his/her belt assembly, and those light sequences will be seen by other First Responders located adjacently and in a position to view the light sequences. Corresponding messages can also be sent to an incident commander at the incident control center outside the rescue scene. In addition, the activities, as based on gesture patterns, and operating environment, as based on sensor data, of each First Responder, together with associated messages and warnings can be recorded at the responder information center. In operation, each First Responder will have a responder lighting and information system, including a wrist lighting assembly, a belt lighting assembly, at least one exposure/environmental assembly and an associated smart device. This system allows First Responders to carry out their jobs without having to hold a separate flashlight. The system is programmable, thus allowing for changes to specific gestures and features of the system.

The gesture-activated lighting and information system and method of the present invention is analogous to the lighting system of the automobile which has twin head lights, high and low beams, left and right turn signals on the front and rear, back up lights, and an emergency flasher. In one embodiment, the present invention contains a heat sensor mounted on the PPE or body of the First Responder to monitor the temperature and issue warnings if dangerous conditions exist, such as the threat of a flashover. The present invention also can contain other mounted exposure/environmental or operational sensors, such as, for example, a smoke measurement unit or a biometric sensor, to monitor and record conditions and to allow for emergency warnings. The lights on the wristband component preferably include high and low beams in order to provide the best possible combination of direct light, flood light and smoke-penetrating light. By pointing the glove-mounted lights on either or both hands, a First Responder can easily light adjacent space up and down and from side to side, which overcomes the inherent limitations of helmet-mounted lights—which only illuminate in the direction a First Responder is facing and can have a restricted range when a First Responder is crawling on his/her hands and knees. For example, if a user has wrist lighting assemblies mounted on the glove of each hand, areas lighting can be directed in two separate directions. The operation of the belt-mounted lighting strip on the rear of the First Responder's jacket allows team members to see where the First Responder ahead of them is going. It can also provide the capability for warning signals of a possible danger ahead or if the team needs to back up and exit to replenish its oxygen supply. In this respect, one of the most important warning signals that can be provided would be one that indicates a dangerous rise in the temperature of the fire—which would correspond to the threat of a flashover and the need for an immediate exit. Other hazardous conditions and biometric data can also be monitored for purposes of providing appropriate warnings and messages.

As described above, the smart phone or similar device allows First Responders to send messages and communicate with other First Responders and team members in the immediate or adjacent area and also to relay messages to the incident control center, including the incident commander, outside the rescue scene. The communications to the incident control center and incident commander can include, but are not limited to, environmental, operational and/or biometric sensor data such as the temperature at various points in the rescue scene, the relative position and movement of First Responders within the rescue scene, and particular messages, such as SOS calls for emergency assistance. As the incident command center monitors the real time reports from First Responders, it can issue warnings to the all the First Responders, for example, of the need to exit the fire scene due to extremely hazardous conditions.

While the system is providing all of these important operating capabilities, the smart device is automatically creating a time-stamped record of the activities of the First Responders and the operating conditions within the rescue scene. The gesture patterns, together with associated movement signals and other messages, as well as sensor data from the smart devices, is assembled and stored in a data repository at the responder information center, which is made available to application programs by an application programming interface. By way of example, but not limitation, this “black box” recording and the related data management applications can be used for post-rescue reporting and analysis of the incident, health and safety exposure reporting, and as a tool for training and education.

Through the data and information gathering and recording aspects of the system and method of the present invention, First Responders have web-based access to their individual operational and exposure records for each incident, as well as overall summaries of their historical operational and exposure record. There is no other system that provides this comprehensive fact-based information. The system and method of the present invention helps increase awareness of the risks of exposure and, in turn, make First Responders more attentive to following safety protocols. This goal follows the maxim “what's measured, improves.” First Responders also have a new capability to share reports of their exposure record with their respective personal physicians, so that, when it is appropriate, a physician can undertake early and periodic screening, diagnosis and treatment for possible health risks. This interaction is crucial to preventing the onset and progression of chronic diseases. Many of these chronic conditions can be treated successfully during their early stages, and, thus, enhance the quality of life for First Responders and their families.

The system and method of the present invention also benefits commanders and fire safety officers by providing web-based access to useful operational and exposure reports on all the First Responders in their department. Commanders and fire safety officers also have exception-reporting capabilities to flag unusual situations based on the ability to customize settings for thresholds of exposure. This exposure information provides value for developing and continuously improving operational procedures to minimize avoidable risks. Further, and as discussed above, the present invention provides a novel communication system with redundant methods of alerting First Responders, on a real-time basis, as to dangerous operational and hazardous conditions.

To overcome the current lack of actual exposure records cited in the referenced studies, the system and method of the present invention further provides medical researchers with the ability to correlate the incidence of chronic diseases with factual data that can be integrated digitally into broad-based studies. As with the two studies referenced above, this information can be invaluable for developing operating procedures and PPE to minimize risks.

Finally the system and method of the present invention provides a cost effective way to implement exposure tracking across the entire spectrum of the firefighting community. When compared with the enormous impact of chronic diseases on the quality of firefighter lives and the huge costs to the service of health and liability insurance, the potential returns from avoiding the onset and progression of chronic diseases are truly significant.

In view of the above, it will be seen that the several objectives of the invention and other advantageous results are obtained. As various changes are or can be made in the above system and method of use without departing from the scope of the invention, it is intended that all matter contained in the description above and below, or shown in the accompanying diagrams, shall be interpreted as illustrative and not in a limiting sense. Specifically, that it is anticipated that the invention may be adapted to meet a range of operating requirements encountered by a variety of Responders.

### BRIEF DESCRIPTION OF THE DRAWINGS

Embodiments of the present invention will now be described, by way of example only, with references to the accompanying drawings for the purpose of illustrating the embodiments, and not for the purpose of limiting the invention, wherein:

FIG. 1 is a master systems block diagram of one embodiment of the data and information gathering system of the present invention.

FIG. 2 is an example of a data reporting format generated by one embodiment of the present invention.

FIG. 3 is a block diagram of the communications system of one embodiment of the present invention.

FIG. 4 is a block diagram of one embodiment of the responder lighting system and method of the present invention.

FIG. 5A is a top view of one embodiment of the wrist lighting assembly of the present invention.

FIG. 5B is a front view of one embodiment of the wrist lighting assembly of the present invention.

FIG. 5C is a front view of one embodiment of the wrist lighting assembly of the present invention.

FIG. 6 is a block diagram of one embodiment of the internal components of the wrist lighting assembly of the present invention.

FIG. 7 is a front view of one embodiment of the belt assembly of the present invention.

FIG. 8 is a diagram of the wrist lighting assembly gestures of one embodiment of the present invention.

FIG. 9 is a block diagram showing the flow of communications between and among First Responders and an incident control center through use of one embodiment of the present invention.

FIG. 10 is a block diagram showing the flow of communications between and among First Responders and a responder information center through use of one embodiment of the present invention.

### DETAILED DESCRIPTION OF THE INVENTION

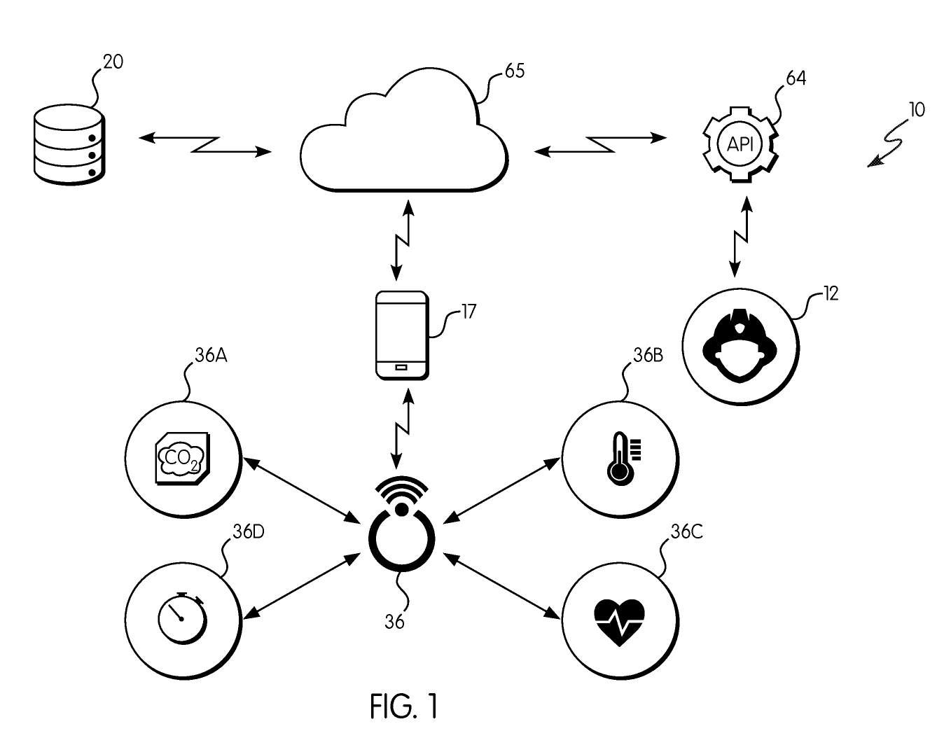

One embodiment of the information and communication system 10 of the present invention is shown in FIG. 1. In particular system 10 includes one or more wearable sensors 36 and one or more programmable smart devices or smart phones 17 that wirelessly communicate with the sensors 36. The smart devices 17 also communicate wirelessly through a virtual cloud network 65 to a responder information center and data repository 20 and an application programming interface (“API”) 64. The API 64, in turn, communicates, preferably in a wireless manner, to an incident control center 12.

The wearable sensors 36 can include a variety of operational and exposure sensors that measure, among things, external environmental conditions in a First Responder setting, movement and position of a First Responder and biometric parameters of a First Responder. By way of example, but without limitation, a sensor 36A for gas exposure, a sensor 36B for external temperature and/or skin temperature of a First Responder, a sensor 36C for heart rate, and a sensor 36D for time exposure. Each of these sensors is worn be a First Responder and may be combined or worn in different locations. For example, sensor 36A is preferably worn on an external location of a First Responder's uniform such that outside gases and fumes, including, but not limited to, oxygen, carbon monoxide and carbon dioxide levels can be measured. Such locations may include, without limitation, a jacket, a belt and a helmet. Temperature sensor 36B preferably is also located on an external part of a First Responder's uniform in order to measure external temperature at a fire scene or other response setting. Such locations, again, may include, without limitation, a jacket, a belt and a helmet. To the extent that skin temperature is to be measured, sensor 36B would be worn and or attached at the skin of a First Responder and at locations including, but not limited to the wrist or neck. Heart rate sensor 36C would be similarly worn at the skin level of a First Responders and at locations similar to where sensor 36B would be worn to measure skin temperature. In this respect, sensors 36B and 36C can, in one embodiment, be combined in a single wearable sensor unit. Sensor 36D measures the time of exposure of a First Responder at a response scene. Sensor 36D can also track other time intervals, including, but not limited to, the time of use of an SCBA, the time of exposure to a gas detected above a predetermined level, the time of exposure above a predetermined external or skin temperature and the time interval of a heart rate above a predetermined level. Other sensors can also be used to measure other operational and exposure conditions or parameters.

The operational and exposure data and information collected by sensors 36 is transmitted wirelessly to smart device 17. Such wireless communication can occur via Bluetooth, LTE, or any other similar technology. A smart device is worn by each First Responder—preferably in a safe location such as inside a pocket or turnout gear. This smart device can be based on any available programming language, such as iOS or Android. Smart device 17 is programmed to process and forward this data and information, via a virtual cloud network 65, to the responder information center and data repository 20 and an API 64. In a preferred embodiment, smart device 17 also includes location tracking and/or GPS capabilities so that the position and movement of a First Responder can be tracked at a response scene where GPS is available. Alternatively, a separate wearable positioning sensor can track this information and communicate the information to the smart device 17.

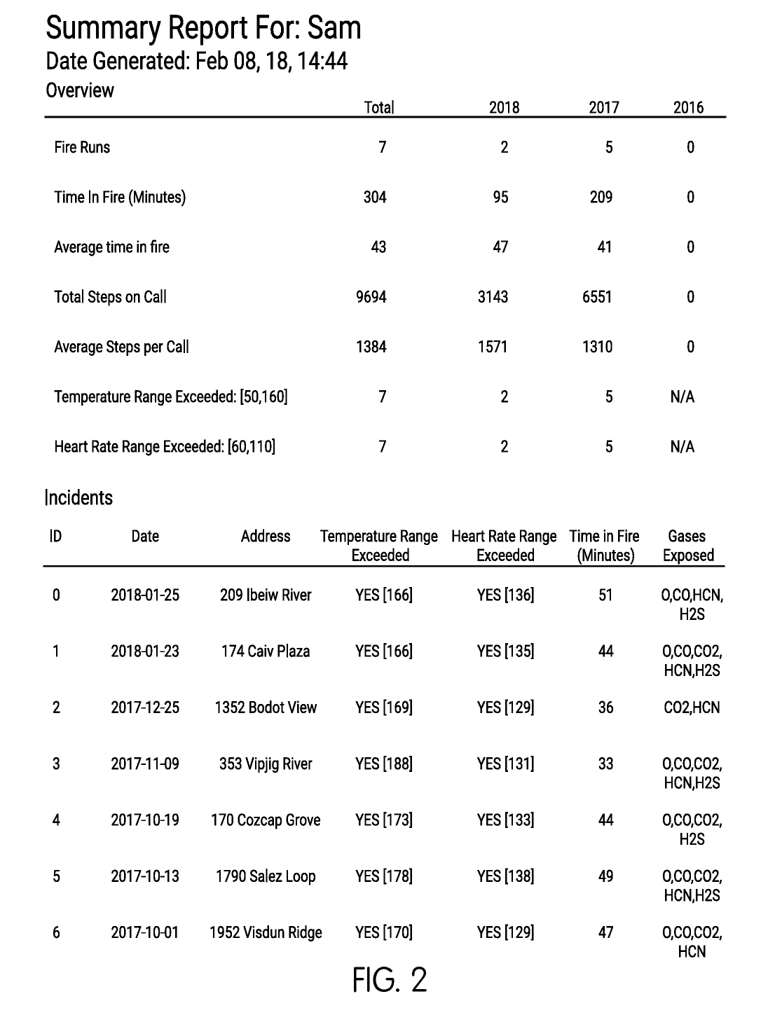

As detailed further below, the responder information center and data repository 20 retains the operational and exposure data and information obtained from sensors 36 and smart device 17. Data repository 20 also functions to create an exposure record for each First Responder through analytics performed on the gathered data and information. For example, and as shown in FIG. 2, the data repository can generate a summary report that provides information for First Responder “Sam” from 2016-18 and in total for: (1) the number of fire runs; (2) the time in fire (minutes); (3) the average time in fire; (4) the total steps per call; (5) the average steps per call; (6) temperature range exceeded; and (7) heart rate range exceeded. In addition, individual incidents are tracked by date and location, together with indications as to whether the predetermined temperature range was exceeded, whether the predetermined heart rate range was exceeded, time in fire for the First Responder, and the gases to which the First Responder was exposed. This information can also be displayed by text and graphically on a location by location by basis, as well as on a corresponding map.

As also detailed more fully below, the API 64 provides an interface with incident control center 12. API 64 can also interface with medical records for each First Responder. The incident control center 12 can be represented by an incident commander or chief, an incident safety officer or by a larger group of individuals having responsibility for reading operational and exposure information/data and communicating with a First Responder in a response setting. More specifically, if operational and exposure data readings identify a dangerous or hazardous condition, the incident control center will communicate a warning to First Responders. Currently, such warnings are provided in audio form through wireless transmitters and receivers. Such technology has limitations, however. For example, background noise may impede the ability to hear audio communications. Also, there may be a need for instantaneous real-time warnings, and the human element in a control center may slow down communications.

As a result, the novel and beneficial methods of communication to and from First Responders. These methods supplemental standard audio communications and provide both redundancy and immediacy for purposes of improving time of response. In this respect, and as detailed more fully below, if measured operational and/or exposure parameters exceed predetermined levels, smart device 17 can trigger real-time warnings to each First Responder. Such warnings can be both audio and visual. In one embodiment, visual warnings can be triggered provided by lighting assemblies attached to the PPE worn by First Responders. Similar triggers and resulting real-time warnings—both audio and visual—can occur at the API level of the system as well. First Responders can also communicate directly between each other by use of hands-free gesture control of lighting assemblies, with these lighting assemblies having corresponding light patterns to communicate various messages and/or signals.

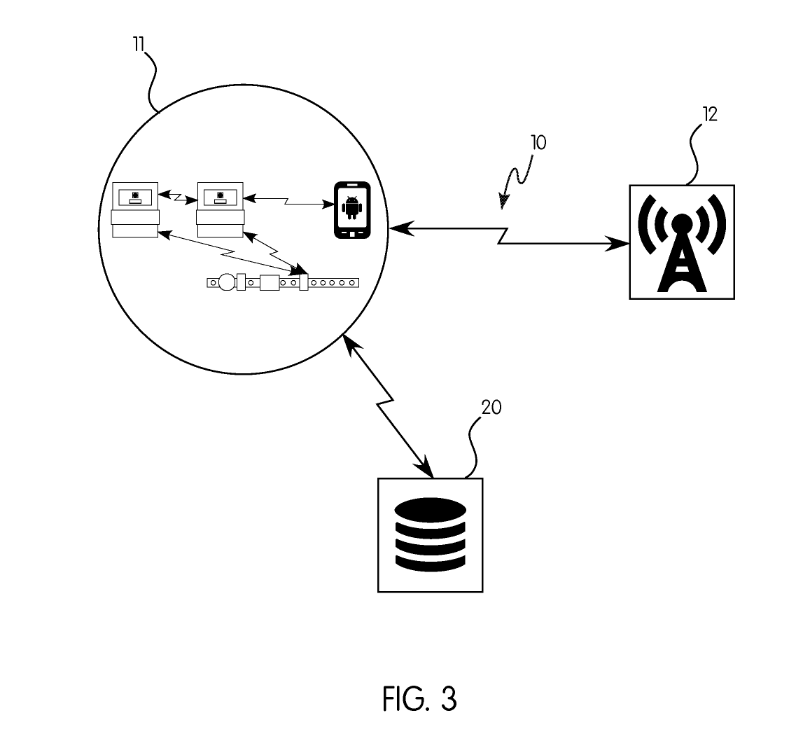

Referring to the FIGS. 3-10, the information and communication system and method of the present invention, in one embodiment, allows for the following gesture-activated communication capabilities: (a) the activation by gestures of lights on the wristband of one First Responder (including the ability to turn LED lights on and off and to switch between a high and low beam); (b) the activation by gestures of light sequences on the belt mounted on the rear of the First Responder's jacket to visually communicate messages, including by way of examples the ability to indicate the Responder is making a left turn or a right turn, an alarm that an emergency situation exists, a signal that the group needs to move out, and a signal that the group needs to meet; (c) the ability for a First Responder to communicate with other Responders in the immediate or adjacent area (including the ability to activate warning lights and send visual signals as described above); (d) the ability to record the activities of each First Responder using the system and method of the present invention, including the movements of the First Responder, the activation of the wristband and belt lights, the visual communication signals generated to other responders, and the environmental sensor data measured on the wristband and belt sensors); (e) the ability to monitor sensor data and issue corresponding warnings or messages when a dangerous situation exists; (f) the ability of the smart phone device to communicate with smart phone devices in the First Responder network; (g) the ability of the smart phone device to relay messages in both directions between First Responders and the incident commander, using light signals to First Responders as based on analysis of sensor and activity data from each First Responder; and (h) the ability of the system to store First Responder activity and sensor data in the responder information center and to access this data for other applications, such as accident scene recreation and analysis and related training.

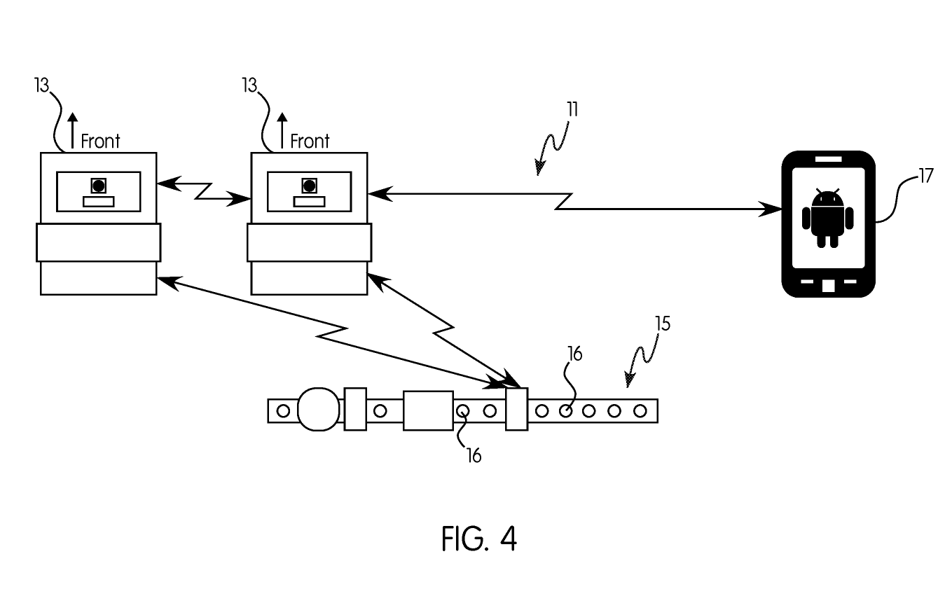

Referring to FIGS. 3 and 4, one embodiment of the communication system and method of the present invention provides a responder lighting and information system 10 including a responder lighting system 11 configured to wirelessly communicate with an existing incident control center 12, and a responder information center 20. Responder lighting and information system 10 provides First Responders and other users with several innovative and useful system capabilities. The gesture-activated responder lighting system 11 provides a First Responder with a hands-free means to light up adjacent space, and to communicate exposure/environmental, operational and/or biometric sensor data and signal movements and warnings to other users in the same immediate area and also to the incident control center 12. The responder information center 20 acquires data captured by the responder lighting system 11 and assembles it in a data repository that, in turn, can be made available to application programs through an application programming interface. Each of these capabilities is described in more detail in the supporting diagrams that follow.

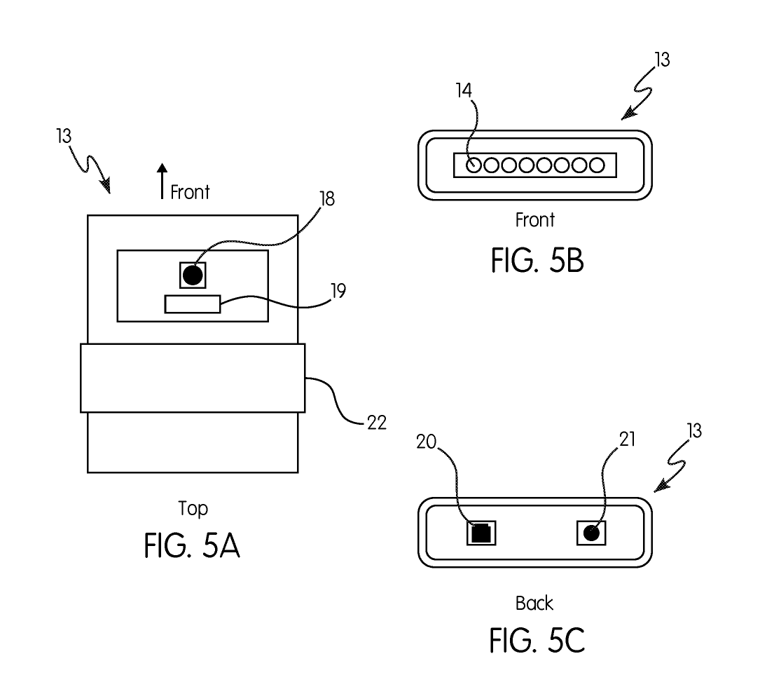

FIGS. 4 and 5 illustrate the components of one embodiment of the responder lighting system 11 which enable First Responders to make gestures to activate lights 14 on the wrist lighting assembly 13 mounted on either or both hands of each First Responder user and lights 16 mounted on the belt assembly 15, which, in turn, is preferably located on the rear of the First Responder's jacket (not shown). The number, color and type of lights 14 and 16 and their positioning on the wrist lighting assembly 13 and belt assembly 15, as well as the method of attaching them, may vary while preserving the functionality of the invention. As described below, the wrist lighting assembly 13 and belt assembly 15 can also include sensors that assimilate various types of information and convey the information to smart device 17. The smart device is located on the user, and, in one embodiment, is held in a protective pocket on the inside of the jacket of the First Responder. The smart device 17 can be replaced by a similar device and the smart device operating system may also vary, including but not limited to Android and iOS or other compatible operating systems. All of the components used in the invention are suitable for use in the various operating environments of First Responders. All of the components utilize existing or known hardware and software operating systems generally available and known to those with skill in the art. As described in further detail below, the smart device 17 enables First Responders and other users to communicate with each other and with the incident control center 12 and also with the responder information center 20 to record contextual information related to the incident and the health and safety of First Responders.

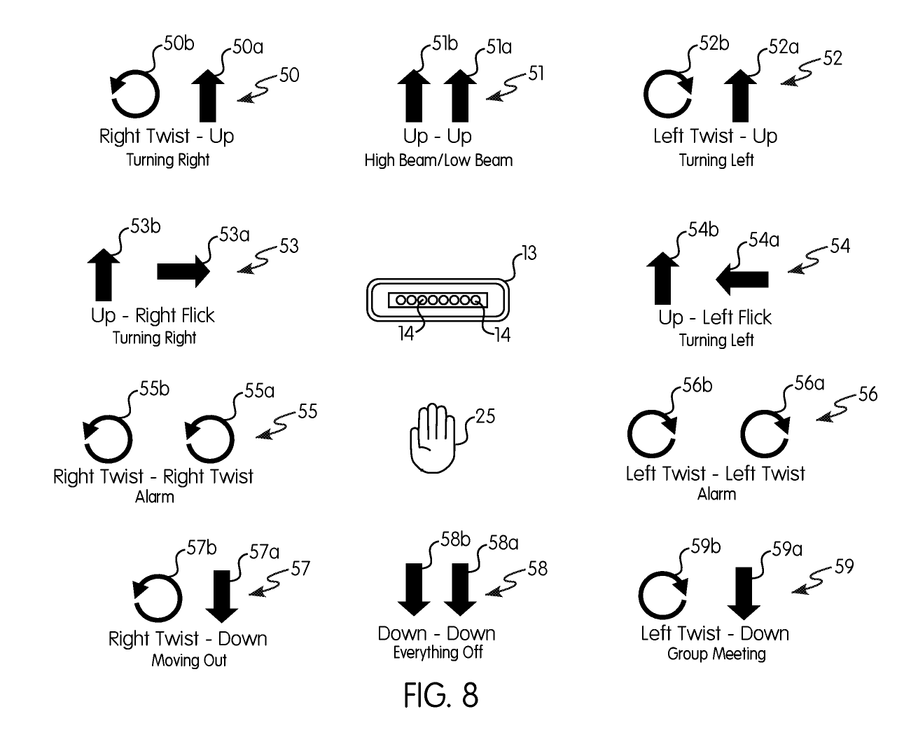

FIG. 5 shows the exterior of one embodiment of the wrist lighting assembly 13 as viewed from the top, with FIG. 5A showing a top view, FIG. 5B showing a front view, and FIG. 5C showing a back or rear view. The wrist lighting assembly lights 14 are shown as light emitting diodes (LEDs) in FIG. 5, but can also be comprised of other light sources and/or a combination of light sources. Lights 14 are used to illuminate the space around a First Responder's space and also can indicate the status of lights 16 on the belt assembly 15 on the rear of the jacket of a First Responder. More specifically, light 14 can indicate whether the lights 16 on belt assembly 15 are on or off. The lights 14 on the wrist lighting assembly 13 can be switched from high to low beam in a preferred embodiment, depending on the situation and environment. The lights 14 on the wrist lighting assembly 13 are normally operated by gestures of the user, described below in connection with FIG. 8, but can also be operated manually by a switch and button assembly 23, including button 18 that operates the high/low beam options of lights 14 and switch 19 that turns lights 14 on and off. The lighting system assembly 11 preferably is battery operated and can be recharged by means of a charging port 20. The lighting system assembly 11 can also be connected to external power by power connector 21. The embodiment of the wrist lighting assembly 13 shown in FIGS. 4 and 5 are attached to user's wrist by wristband 22. The size and positioning of the components on the wrist lighting assembly 13 and the method of attaching the assembly 13 to a user's wrist may vary while preserving the functionality of the invention.

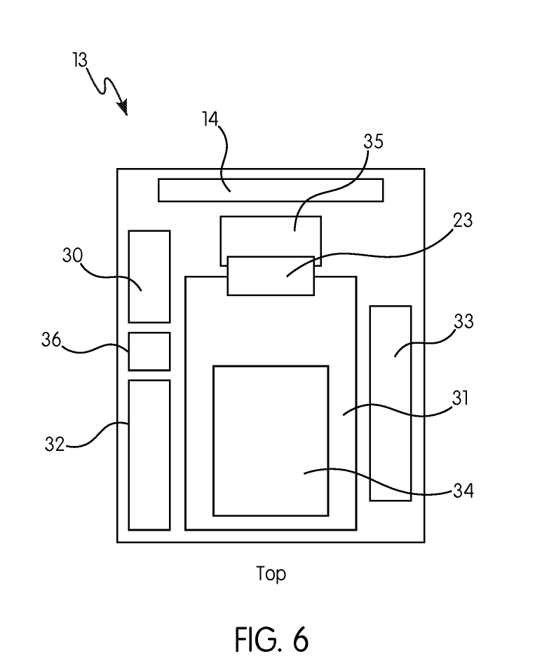

FIG. 6 shows the interior of one embodiment of the wrist lighting assembly 13, including lights 14 (shown, without limitation as LEDs), an inertial measurement unit 30 for gesture control and measuring motion of the lighting assembly 13 as well as movement of the associated user, a micro controller 31 for controlling the operation of the components of the light assembly 13, the switch and button assembly 23 for manual control of lights 14, a wireless transceiver 32 for wireless communication with belt assembly 15, a transmitter/receiver 33 for communication with smart device 17 worn by other First Responders, a battery 34, a battery boost converter 35 for recharging the battery 34, and one or more exposure/environmental, operational or biometric sensors 36, such as temperature sensors, smoke detection and measurement sensors, and biometric data sensors. In the case of biometric sensors, leads may be used to locate related sensor components on parts of the user's body, such as the inner wrist, to assist in measuring vital signs, such as heart rate. Transmitter/receiver 33 can be an RC transmitter/receiver or other suitable device. The components used in the wrist lighting assembly 13 are standard for operation of the invention and are known to those with skill in the art. As other methods of use are encountered, the number and type of components and lights and their positioning may vary while preserving the functionality of the invention. The components are suitable for use in the operating environment of First Responders.

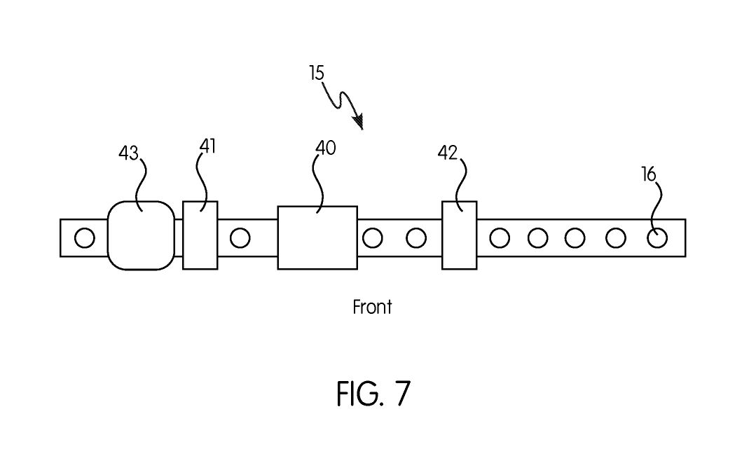

FIG. 7 shows one embodiment of the components of the belt assembly 15, which include lights 16 (shown, without limitation, as multicolor LEDs), a battery 40, an optional transmitter/receiver 41 for wireless communication with the wrist lighting assemblies 14, one or more exposure/environmental, operational and/or biometric sensors 42, such as smoke detection and measurement, and a micro controller 43 for controlling the operations of the components of the belt assembly. In one embodiment, the lights 16 are activated by movement and specific gestures of the wrist lighting assembly 13 in various predetermined colors, sequences and directions to provide predetermined left and right turn signals or various warnings signals such as backing up or emergency. For example, a predetermined gesture by a first user of the wrist lighting assembly 13 can operate to cause lights 16 to light in a sequenced pattern from right to left as seen by someone standing behind the first user. Similarly, the same gesture can act to operate a corresponding light pattern from lights 14 on wrist lighting assembly 13. The number, type and positioning of lights 16 and sensors 42 on the belt assembly 15 and the method of attaching the components to the belt assembly 15 and attaching the belt assembly 15 to the First Responder's jacket or other garments may vary while preserving the functionality of the invention. The sensors 42 can, again, vary and include, without limitation, temperature sensors, smoke detection and measurement sensors, and biometric data sensors. In the case of biometric sensors, leads may be used to locate related sensor components on parts of the user's body, such as near the heart or neck, to assist in measuring vital signs, such as heart rate. Transmitter/receive 41 can be an RC transmitter/receiver or other suitable device. These sensors can also be located on other parts of a First Responder's uniform and/or the First Responder. The components of the belt assembly 15 are standard for operation of the invention and are known to those with skill in the art and may vary as the invention is adapted to other operating environments and user requirements.

In conjunction with the smart device 17 of the system and method of the present invention, differing types of verbal and non-verbal messages can be conveyed among and between First Responders and also an incident control center 12. One message system exists through the predetermined gesture-activated patterns created by wrist movements of a user's wrist. Such movements are made with only one wrist and generate corresponding gesture patterns that are transmitted to the user's smart device 17 and processed by the smart device 17 to generate lighting activation and/or lighting sequence commands. The lighting activation and/or lighting sequence commands are then transmitted wirelessly back to the lighting wrist assembly 13 and/or belt assembly 15. Lighting activation commands can cause (i) the lights 14 and 16, respectively, of a user's lighting wrist assembly 13 and belt assembly 15 to turn on and off, (ii) the lights 14 of a user's lighting wrist assembly 13 to switch between high or low beams, and (iii) the lights 14 and 16, respectively, of a user's lighting wrist assembly 13 and belt assembly 15 to signal a warning. The warning signal on the lighting wrist assembly 13 can be a flashing high beam, while the warning signal for the lights 16 of the belt assembly 15 is a predetermined sequence, such as the flashing of a particular color or alternating colors. In one embodiment of the present invention, the lighting activation and lighting sequence commands are transmitted directly, as applicable, to both the lighting wrist assembly 13 and the belt assembly 15. In another embodiment, the lighting activation and lighting sequence commands are transmitted directly to the lighting wrist assembly 13 and, from there, by wireless communication to the belt assembly 15. This communication pathway can also be reversed such that the lighting activation and lighting sequence commands are transmitted directly to the belt assembly 15 and, from there, by wireless communication to the lighting wrist assembly 13. In a further alternative embodiment, these same lighting activation commands can be conveyed between user smart devices 17 to activate the lights 14 and 16 of the responder lighting and information systems 11 of all users in the area to be activated in a similar manner.

The system and method of the present invention also generates messages through transmission of sensor data. More specifically, sensors 36 and 42 located, respectively, on the wrist lighting assembly 13 and the belt assembly 15 (or elsewhere) generate data that is transmitted to the user's smart device 17. In this embodiment, there is at least environmental sensor 36 or 42—a heat sensor—that is located on either of both of the wrist lighting assembly 13 and belt assembly 15. Environmental data is processed by the smart device 17 and, if a dangerous condition is observed—such as a high temperature or rapid temperature rise—the smart device 17 generates a warning signal that is transmitted wirelessly to either or both of the wrist lighting assembly 13 and belt assembly 15. This warning signal triggers the warning lights 14 and 16 described above, and this same warning signal can be conveyed to the smart devices 17 of other users to triggers similar warning lights 14 and 16 in their respective responder lighting systems 11. Again, if the warning signal is directed to either the wrist lighting assembly 13 or belt assembly 15, this receiving assembly retransmits the signal to the other assembly.

In a further alternative embodiment of the system and method of the present invention, certain specific warning signals, such as a flashover in a fire (with associated high heat), can be generated by the controller 31 or 43 of a particular assembly in order to directly trigger warning lights 14 and 16 in both assemblies (i.e., both the wrist lighting assembly 13 and belt assembly 15) and also to other First Responders in the adjacent area.

Warning messages and other commands associated with lighting sequences can also be generated by an incident commander and/or an incident control center 12 based on review of the activity information and sensor data that is transmitted wirelessly be each user to the incident control center 12. Such messages and commands can be directed to the smart devices 17 of particular users or all users and the smart devices 17 can transmit the messages and commands to the wrist lighting assembly 13 and belt assembly 15 in the same manner as described above in connection with communications between First Responder users.

FIG. 8 shows examples of various types of predetermined gestures 50-59 of wrist lighting assembly 13, as mounted on a hand 25, that activate the operation of the lights 14 and 16, respectively, mounted on the wrist lighting assembly 13 and belt assembly 15. The lighting assembly 13 can be mounted on the right or left hand of a user, and the lights 16 on belt assembly 15 and/or the lights 14 of lighting wrist assembly 13 are activated by gestures of a single hand 25. Each of the gestures on FIG. 8 consists of two movements, reading from left to right as illustrated on FIG. 8. By way of example, but not limitation, gesture 51 corresponds to an upward movement of the wrist 51a followed immediately by a second upward movement of the same wrist 51b to activate or turn on the lights 14 of the wrist lighting assembly to a high beam and also to activate or turn on the lights 16 of belt assembly 15. By repeating this gesture 51 the lights 14 on the wrist lighting assembly 13 are switched from the high beam to the low beam; by repeating gesture 51 again, the lights 14 on the wrist lighting assembly 13 are switched from the low beam to the high beam. Gesture 58 turns off lights 14 and 16 and corresponds to a downward movement of the wrist 58a followed immediately by a second downward movement of the same wrist 58b. Gesture 50 activates the lights 16 on the right side of the belt assembly 15 to signal a right turn and corresponds to a right counterclockwise twist of the wrist 50a followed immediately by an upward wrist movement 50b. Gesture 53 generates a similar right turn signal and corresponds to an upward movement of the wrist 53a followed immediately by right movement of the wrist 53b. Gesture 52 activates the lights 16 on the left side of the belt assembly 15 to signal a left turn and corresponds to a left clockwise twist of the wrist 52a followed immediately by an upward wrist movement 52b. Gesture 54 generates a similar left turn signal and corresponds to an upward movement of the wrist 54a followed immediately by a left movement of the wrist 54b. Gesture 55 signals an alarm or emergency signal through a predetermined pattern and or sequence of lights 16 and corresponds to a right counterclockwise twist of the wrist 55a followed immediately by another right counterclockwise twist of the wrist 55b. Gesture 56 also signals an alarm or emergency through a predetermined pattern and or sequence of lights 16 and corresponds to a left clockwise twist of the wrist 56a followed immediately by another left clockwise twist of the wrist 56b. Gesture 57 signals a move out of the rescue scene and corresponds to a right counterclockwise twist of the wrist 57a followed immediately by a downward movement of the wrist 57b. Gesture 59 signals, through a predetermined pattern and or sequence of lights 16, for the crew in the immediate vicinity to come together and corresponds to a left clockwise twist of the wrist 59a followed immediately by a downward movement of the wrist 59b. The lighting system 11 is programmable, through the programming capabilities of a standard smart phone/device (through loaded custom applications to be developed by a user of responder lighting and information system 10) such that these gestures can be easily modified or supplemented. It is anticipated that the gestures may be modified from time to time based on operating environments and user requirements.

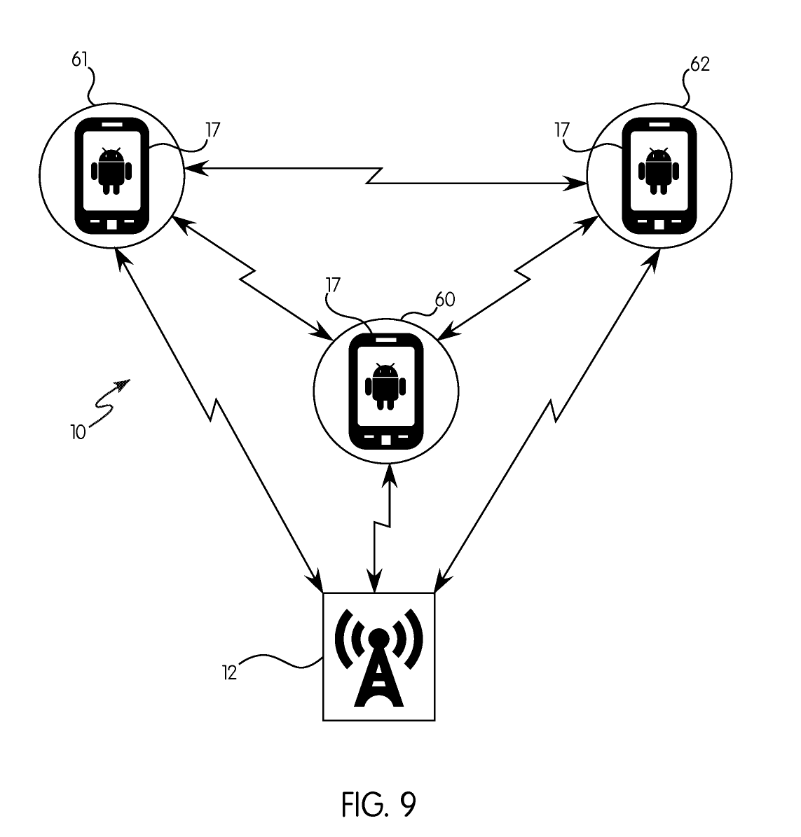

FIG. 9 illustrates one embodiment of the interaction of the responder lighting system 11 with an incident control center 12. The upper portion of FIG. 9 illustrates the ability for one First Responder 60 to use the smart device 17 in his/her responder lighting system 11 to communicate with the smart devices 17 and associated responder lighting systems 11 of other adjacent First Responder users or crew members 61 and 62 who are within short range wireless connectivity (normally thirty feet). Crew members 61 and 62 may also be able to communicate directly depending on the distance between them. As described above, this communication network allows for certain warning signals and/or messages to trigger warning lights as to the responder lighting systems 11 of all proximate First Responder users. In addition, First Responder 60 can send a signal with flashing lights of the lighting system and method of the present invention to First Responders 61 and 62 located behind First Responder 60 to indicate, for example, an emergency or low-oxygen situation that requires the crew to evacuate immediately. The lower portion of FIG. 7 illustrates the ability of responder lighting and information system 10 to communicate with the incident control center 12 outside the rescue scene via a wireless communications network using smart devices 17. Such communications may be used, for example, to track the relative location and status of responders through the inertial measurement unit, to create an approximate heat map of the rescue scene, and to send emergency signals in either direction.

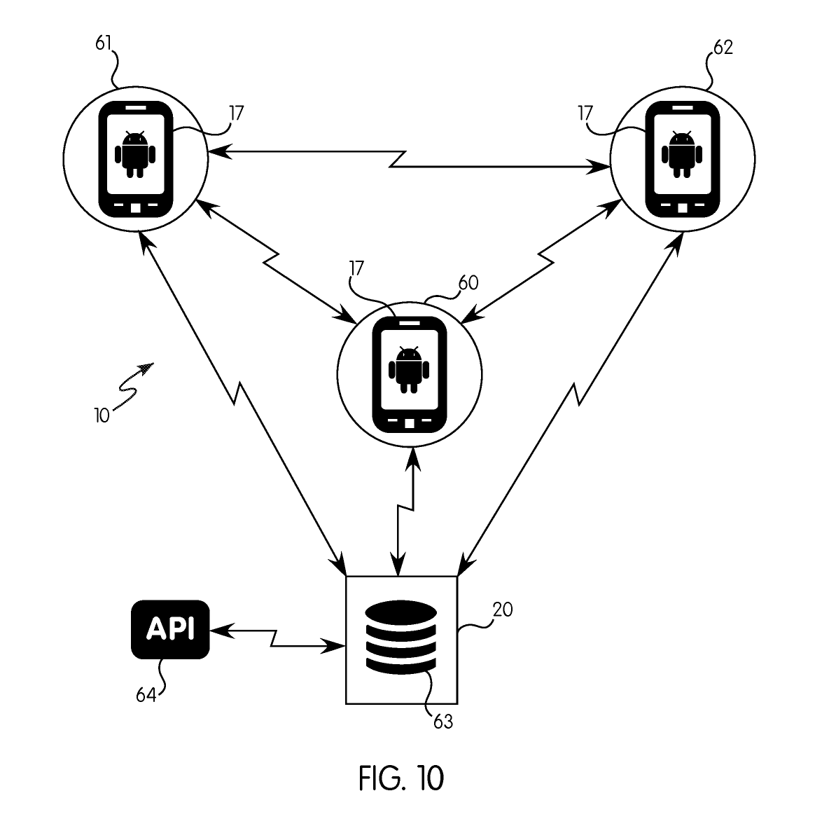

FIG. 10 illustrates one embodiment of the interaction of the responder lighting system 11 with an incident control center 20. In particular, FIG. 10 illustrates the components and functionality of the responder information center 20, which, like an airplane “black box”, stores the activity and environmental data captured by the adaptable programming capability of the smart device 17 or other similar device that is an integral part of the responder lighting system 11. In one embodiment, the responder lighting and information system 10 is used with an Android device, but can also be programmed for other smart devices using iOS and other similar operating systems. The data captured by the sensors 36 and 42—located anywhere on the First Responder or the First Responder uniform—and smart device 17 during the operation of the responder lighting system 11 is recorded on the smart device 17 and assembled into a data repository 63. The data repository 63 corresponds to a custom-designed data set to be developed and implemented by users of system 10 that includes, by way of example, the status and relative location of responders, temperature and other environmental data such as smoke, and biometric data such as heart rate. This data can be accessed by application programs through an API 64 and a related data management system that incorporates standard software and is configured for development of data fields for storage and retrieval of desired First Responder information and data. The API 64 and associated data management system can vary in design, hardware and software, provided that the stored data can be used for real time decision support and for later analysis and educational purposes. In particular, this information can be used to improve operational procedures and for training purposes. In addition, the application programs and associated data fields that can be developed for use with the present invention may include, by way of example, but not limitation, location and movement of responders in relation to each other and the rescue scene, a temperature map of the fire scene over time, early warnings of imminent danger (in addition to warning messages generated otherwise by the user, the lighting wrist assembly and/or the incident control center), analytical reports of environmental data, and responder exposure to high temperature and smoke.

It will be understood that each of the elements of the invention described above, or two or more together, may also find a useful application in other types of applications differing from the types described above. While the invention has been illustrated and described above, it is not limited to the details shown, since it will be understood that various omissions, modifications, substitutions and changes in the forms and details of the system illustrated and its method of operation can be made by those skilled in the art without departing in any way from the spirit of the present invention.

What is claimed is:

1. A system for operational and exposure information recording and nonverbal communication for use by one or more emergency scene first responders as users, the system comprising:
at least one sensor worn by the one or more first responders, the sensor capable of measuring operational or exposure conditions of the one or more first responders at an emergency scene;
a responder information center configured to wirelessly receive and store data relating to the operational or exposure conditions of the one or more first responders;
an incident control center configured to wirelessly communicate with the one or more first responders concerning the operational or exposure conditions of the one or more first responders; and
a smart device associated with the one or more first responders, the smart device configured to wirelessly communicate the measured operational or exposure conditions from the at least one sensor, the responder information center, and the incident control center.

2. The system of claim 1, wherein the system further comprises an application programming interface configured to facilitate analysis of the measured operational or exposure conditions with the at least one sensor and communication between the one or more first responders and the incident control center.

3. The system of claim 1, wherein the responder information center identifies and generates a report as to when measured operational or exposure conditions from the at least one sensor exceeds a predetermined parameter.

4. The system of claim 1, wherein the responder information center identifies and generates a report as to the geographic location of the one or more first responders.

5. The system of claim 1, wherein the incident control center identifies when measured operational or exposure conditions from the at least one sensor exceeds a predetermined parameter and communicates a corresponding warning to the one or more first responders.

6. The system of claim 5, wherein the warning is communicated nonverbally.

7. The system of claim 6, wherein the system further comprises at least one lighting assembly worn by each the one or more first responders and the nonverbal warning is communicated through predetermined light sequences generated on the at least one lighting assembly.

8. The system of claim 7, wherein first responders can communicate nonverbally with each other through activation of the predetermined light sequences generated on the at least one lighting assembly on each first responder.

9. The system of claim 8, wherein the nonverbal communication between first responders is gesture activated.

10. The system of claim 1, wherein the at least one sensor is selected from the group consisting of a heat sensor configured to measure skin temperature, a heat sensor configured to measure external temperature, a motion sensor, a sensor for gas detection exposure, a sensor for heart rate, a biometric sensor and a sensor for time exposure.

11. A method of recording and nonverbally communicating operational and exposure information from one or more emergency scene first responders as users, the method comprising:
measuring operational or exposure conditions of the one or more first responders at an emergency scene by at least one sensor worn by the one or more first responders;
wirelessly communicating the operational or exposure conditions of the one or more first responders through a smart device associated with the one or more first responders and to a responder information center for analysis and storage; and
wirelessly communicating the operational or exposure conditions of the one or more first responders through the smart device and to an incident control center for analysis and generation of communications to the one or more first responders.

12. The method of claim 11, wherein the responder information center identifies and generates a report detailing when the operational or exposure conditions of the one or more first responders exceed a predetermined parameter.

13. The method of claim 11, wherein the incident control center identifies when the operational or exposure conditions of the one or more first responders exceed a predetermined parameter and generates a corresponding warning message to the one or more first responders.

14. The method of claim 11, wherein the warning message is nonverbal.

15. The method of claim 12, where the nonverbal warning message is communicated through predetermined light sequences generated on at least one lighting assembly worn by each the one or more first responders.

16. The method of claim 11, wherein the at least one sensor is selected from the group consisting of a heat sensor configured to measure skin temperature, a heat sensor configured to measure external temperature, a motion sensor, a sensor for gas detection exposure, a sensor for heart rate, a biometric sensor and a sensor for time exposure.

17. A hands free gesture-activated lighting and information system for use by one or more emergency scene first responders as users and that is configured to communicate wirelessly with an incident control center, the system comprising:
a responder information center configured to receive and store data relating to the activities of, and the environmental conditions around, the users in an emergency scene; and
a responder lighting system for use by each user, each responder lighting system comprising:
at least one wrist lighting assembly mounted on a wrist of each user, the wrist lighting assembly comprising lights configured to provide area lighting and a warning signal, a power supply, a controller for controlling the operation of the components of the at least one lighting wrist assembly, an inertial measurement unit for tracking hands free gesture movements of the wrist lighting assembly and user movement, a wireless transmitter for transmitting predetermined hands free gesture movement patterns and user movement, and a receiver for receiving lighting sequence commands and warning messages;
a belt assembly attached to the rear of each user comprising front and rear lights configured to project predetermined lighting sequences to convey corresponding visual messages, a power supply, a controller for controlling the operation of the components of the belt assembly, a receiver for receiving lighting sequence commands and warning messages;
at least one sensor and a transmitter for transmitting sensor data located on each user, the sensor capable of measuring operational or exposure conditions of the user;
a programmable smart device that communicates wirelessly with the wrist lighting assembly, the belt assembly, the incident control center, and the responder information center, whereby:
the wrist lighting assembly transmits the predetermined hands free gesture patterns wirelessly to the smart device, the smart device processes the predetermined hands free gesture patterns and generates corresponding predetermined lighting sequence commands, the smart device transmits the predetermined lighting sequence commands wirelessly to the belt assembly, and the lights of the belt assembly project predetermined lighting sequences, corresponding to the predetermined lighting sequence messages, to other users positioned in viewing range of the belt assembly lights;
data from the at least one sensor is communicated wirelessly to the smart device, and, based on processing of the data, the smart device wirelessly communicates a warning message to the responder lighting system of each user to activate corresponding warning lights on the wrist lighting assemblies and belt assemblies of all users;
data from the at least one sensor is communicated wirelessly from the smart device to the incident control center, and, based on this data, the incident control center wirelessly communicates a warning message to the smart device of each user for wireless transmission to the responder lighting system of each user to activate corresponding warning lights on the wrist lighting assemblies and belt assemblies of all users in the adjacent area;
the predetermined hands free gesture patterns and movements of the user and the data from the at least one sensor are communicated wirelessly to the smart device, and the smart device wirelessly communicates the hands free gesture patterns and sensor data to the responder information center for data storage, management and retrieval.

18. The hands free gesture-activated light and information system of claim 17, wherein the lights of lighting wrist assembly are configured to turn on and off and between high and low beams, and whereby hands free gestures of the lighting wrist assembly are configured to turn the lights on and off and between high and low beams.

19. The hands free gesture-activated light and information system of claims 17 or 18, wherein the programmable smart device communicates wirelessly directly between proximate users whereby warning signals and messages can be sent directly between proximate users.

20. The hands free gesture-activated light and information system of claim 17, wherein the at least one sensor is a heat sensor and the lighting wrist assembly or belt assembly on which the heat sensor is located further comprises a wireless transmitter/receiver for direct communication of a heat warning message to the smart devices of other users to activate corresponding warning lights on the wrist lighting assemblies and belt assemblies of all users.

21. The hands free gesture-activated light and information system of claim 17, wherein the at least one sensor is selected from the group consisting of a heat sensor configured to measure skin temperature, a heat sensor configured to measure external temperature, a motion sensor, a sensor for gas detection exposure, a sensor for heart rate, a biometric sensor and a sensor for time exposure.

22. The hands free gesture-activated light and information system of claim 17, wherein at least one sensor is located on the lighting wrist assembly and the belt assembly.

23. The hands free gesture-activated light and information system of claim 17, wherein the predetermined lighting sequences correspond to predetermined lighting sequence messages selected from the group consisting of turning right, turning left, backing up, warning, exit the scene, and the need for a team of first responder users to come together.

24. The hands free gesture-activated light and information system of claim 17, wherein the programmable smart device is configured to be reprogrammable to allow for modifications and additions to the predetermined hands free gesture patterns, the predetermined lighting sequence commands and the predetermined lighting sequence.

25. The hands free gesture-activated and information system of claim 17, wherein the responder information center comprises a data repository and an application programming interface, and wherein the data received by the responder information center wherein the data in the responder information is retrieved for purposes of accident scene recreation, analysis and user training.

26. A method of using a hands free gesture-activated lighting and information system for use by one or more emergency scene first responders as users and that is configured to communicate wirelessly with an incident control center, the system comprising:
a responder information center configured to receive and store data relating to the activities of, and the environmental conditions around, the users in an emergency scene; and
a responder lighting system for use by each user, each responder lighting system comprising:
at least one wrist lighting assembly mounted on a wrist of each user, the wrist lighting assembly comprising lights configured to provide area lighting and a warning signal, a power supply, a controller for controlling the operation of the components of the at least one lighting wrist assembly, an inertial measurement unit for tracking hands free gesture movements of the wrist lighting assembly and user movement, a wireless transmitter for transmitting predetermined hands free gesture movement patterns and user movement, and a receiver for receiving lighting sequence commands and warning messages;
a belt assembly attached to the rear of each user comprising front and rear lights configured to project predetermined lighting sequences to convey corresponding visual messages, a power supply, a controller for controlling the operation of the components of the belt assembly, a receiver for receiving lighting sequence commands and warning messages;
at least one sensor and a transmitter for transmitting sensor data located on each user, the sensor capable of measuring operational or exposure conditions of the user;
a programmable smart device that communicates wirelessly with the wrist lighting assembly, the belt assembly, the incident control center, and the responder information center, whereby, in operation, the method comprises the steps of:
transmitting the predetermined hands free gesture patterns wirelessly from the wrist lighting assembly to the smart device, processing the predetermined hands free gesture patterns and generates corresponding predetermined lighting sequence commands by the smart device, transmitting the predetermined lighting sequence commands wirelessly from the smart device to the belt assembly, and projecting predetermined lighting sequences, corresponding to the predetermined lighting sequence messages, from the lights of the belt assembly to other users positioned in viewing range of the belt assembly lights;
communicating data from the at least one sensor wirelessly to the smart device, and, based on processing of the data, wirelessly communicating a warning message from the smart device to the responder lighting system of each user to activate corresponding warning lights on the wrist lighting assemblies and belt assemblies of all users;
wirelessly communicating data generated by the at least one sensor from the smart device to the incident control center, and, based on this data, wirelessly communicating a warning message from the incident control center to the smart device of each user for wireless transmission to the responder lighting system of each user to activate corresponding warning lights on the wrist lighting assemblies and belt assemblies of all users in the adjacent area;
wirelessly communicating the predetermined hands free gesture patterns and movements of the user and the data from the at least one sensor to the smart device, and wirelessly communicating the hands free gesture patterns, user movements and sensor data from the smart device to the responder information center for data storage, management and retrieval.

27. The method of using the hands free gesture-activated light and information system of claim 26, wherein the lights of lighting wrist assembly are configured to turn on and off and between high and low beams, and the method further comprises the step of using hands free gestures of the lighting wrist assembly to turn the lights on and off and between high and low beams.

28. The method of using the hands free gesture-activated light and information system of claims 26 or 27, wherein the programmable smart device communicates wirelessly directly between proximate users whereby warning signals and messages can be sent directly between proximate users.

29. The method of using the hands free gesture-activated light and information system of claim 26, wherein the at least one sensor is a heat sensor and the lighting wrist assembly or belt assembly on which the heat sensor is located further comprises a wireless transmitter/receiver, and the method further comprises the step of direct communicating a heat warning message to the smart devices of other users to activate corresponding warning lights on the wrist lighting assemblies and belt assemblies of all users.

30. The method of using the hands free gesture-activated light and information system of claim 26, wherein the at least one sensor is selected from the group consisting of a heat sensor configured to measure skin temperature, a heat sensor configured to measure external temperature, a motion sensor, a sensor for gas detection exposure, a sensor for heart rate, a biometric sensor and a sensor for time exposure.

31. The method of using the hands free gesture-activated light and information system of claim 26, wherein at least one sensor is located on the lighting wrist assembly and the belt assembly.

32. The method of using the hands free gesture-activated light and information system of claim 26, wherein the predetermined lighting sequences correspond to predetermined lighting sequence messages selected from the group consisting of turning right, turning left, backing up, warning, exit the scene, and the need for a team of first responder users to come together.

33. The method of using the hands free gesture-activated light and information system of claim 26, wherein the method further comprises the step of reprogramming programmable smart device to allow for modifications and additions to the predetermined hands free gesture patterns, the predetermined lighting sequence commands and the predetermined lighting sequence.

34. The method of using the hands free gesture-activated light and information system of claim 26, wherein the responder information center comprises a data repository and an application programming interface.

35. The method of using the hands free gesture-activated light and information system of claim 26, wherein the method further comprises the step of retrieving the data in the responder information center for purposes of accident scene recreation, analysis and user training.

36. The system of claim 1 or 17, wherein the smart device is configured for location tracking.

37. The method of claim 11 or 26, wherein the smart device is configured for location tracking.
